(19) United States
(12) Patent Application Publication
(10) Pub. No.: US 2011/0186159 A1
(43) Pub. Date: Aug. 4, 2011

(54) GAS DISTRIBUTION MODULE AND GAS DISTRIBUTION SCANNING APPARATUS USING THE SAME

(75) Inventor: Ming-Tung CHIANG, Hsinchu City (TW)

(73) Assignee: INDUSTRIAL TECHNOLOGY RESEARCH INSTITUTE, Hsin-Chu (TW)

(21) Appl. No.: 12/977,407

(22) Filed: Dec. 23, 2010

(30) Foreign Application Priority Data
Feb. 1, 2010 (TW) 099102782

(51) Int. Cl. A23G 9/28

(52) U.S. Cl. 137/602

(57) ABSTRACT

The present invention provides a gas distribution module, which is capable of directing a plurality of different gases and rendering the gases to be diffused evenly by the turning channels disposed within the module so that the gases can be distributed uniformly within the gas distribution module and thereby being delivered onto a substrate evenly. In addition, the present further provides a gas distribution scanning apparatus, which has a displacement driving unit coupled to the gas distribution module or a carrier supporting the substrate so that the gases can be delivered uniformly onto the substrate by means of the linear movement of the gas distribution module or the carrier.

### TECHNICAL FIELD

The present disclosure relates to a gas distribution module, and more particularly, to a gas distribution module and a gas distribution apparatus using the same that is capable of uniformly distributing gases onto substrates in a scanning manner.

### BACKGROUND

With rapid advance and popularity of using means of chemical vapor deposition (CVD) in thin film coating process, it is becoming more and more important to have a gas distribution module capable of spraying gases into its corresponding reaction chamber uniformly.

Please refer to FIG. 1, which is a schematic diagram showing a gas distribution plate assembly disclosed in U.S. Pat. No. 7,270,713. As shown in FIG. 1, the gas distribution plate assembly is a multi-plate structure 10 composed of three perforated plates 100, whereas each perforated plate is configured with a plurality of orifice holes. Thereby, gases can be mixed in advance and then being distributed uniformly into a process chamber 11 before being spraying out through trumpet-like outlet holes. Moreover, in U.S. Pat. No. 6,478,872, a shower head having separate gas passages for preventing different reaction gases from mixing with each other before being sprayed is disclosed, in which the shower head is substantially a metal disc that is designed with independent gas passages, provided for guiding different reaction gases to be delivered via different gas outlets that are independent to each other.

However, with the advance of thin film coating process, substrates to be processed are getting larger and larger, resulting that the size of the gas distribution module has to be increased with the increasing processing surface area of the substrate. Nevertheless, with the increasing size of the gas distribution module, the working hour and cost will be increased as the consequence of this size increasing. Not to mention that the larger the gas distribution module is, the more orifice holes are required to be formed on the gas distribution module, resulting that the difficulty for providing uniform distribution of gases passing through the gas distribution module is increasing.

Therefore, for providing uniform distribution of gases passing through the gas distribution module and lowing the manufacturing cost of the same that is especially to be adapted for processing large-size substrates, the focal point is to simplify the structure complexity of the gas distribution module.

### SUMMARY

The present disclosure relates to a gas distribution module, adapting a single-layer design for enabling the same to be manufactured without complex machining and assembling processes so as to lower its manufacture cost while capable of effectively providing uniform distribution of gases passing through the same.

The present disclosure relates to a gas distribution module, adopting a design of separating the diffusion zone from the mixing zone in the gas distribution module, capable of feeding reaction gases into a small diffusion chamber for enabling the reaction gases to diffuse uniformly and then enabling the evenly distributed gases to be mixed before being sprayed out of the gas distribution module or to be sprayed out of the gas distribution module before being mixed while ensuring the mixture of gases to be distributed uniformly on a substrate.

The present disclosure relates to a gas distribution module, capable of performing a linear displacement movement to move across a surface of a substrate for enabling gases being spraying out of the same to be distributed uniformly on the surface, that is especially adapted for providing uniform distribution of gases on large-size substrates that are processed with satisfactory yield.

In an exemplary embodiment, the present disclosure provides a gas distribution module, comprising: a frame; a pair of diffusion chamber assemblies, formed inside the frame; a pair of gas inlet assemblies, connected respectively in communication with the pair of diffusion chamber assemblies; and a gas outlet assembly, formed inside the frame while being connected in communication with the pair of diffusion chamber assemblies; wherein the gas outlet assembly is further configured with at least one outlet hole, each being arranged at a position on a surface of the frame.

In another exemplary embodiment, the present disclosure provides a gas distribution scanning apparatus, comprising: a gas distribution module; and a displacement driving unit, for enabling a displacement movement of at least one dimension in a manner that the gas distribution module is driven to move relative to a substrate that is disposed at a side of the same; wherein the gas distribution module is further comprised of: a frame; a pair of diffusion chamber assemblies, formed inside the frame; a pair of gas inlet assemblies, connected respectively in communication with the pair of diffusion chamber assemblies; and a gas outlet assembly, formed inside the frame while being connected in communication with the pair of diffusion chamber assemblies, and the gas outlet assembly having at least one outlet hole, each being arranged at a position on a surface of the frame.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a gas distribution plate assembly disclosed in U.S. Pat. No. 7,270,713.

FIG. 2A and FIG. 2B are a perceptive view and a cross section view of a gas distribution module according to a first embodiment of the present disclosure.

FIG. 2C is a three-dimensional view of a gas distribution module according to the first embodiment of the present disclosure.

FIG. 2D is a schematic diagram showing how reaction gases are being guided to flow independently into two separated diffusion chambers and then into a mixing chamber to be mixed according to the present disclosure.

FIG. 3A is a schematic diagram showing one type of outlet hole arrangement in the gas distribution module of FIG. 2A.

FIG. 3B and FIG. 3C are a perceptive view of a gas distribution module with a outlet hole arrangement different from the one shown in FIG. 2A, and a schematic diagram showing another type of outlet hole arrangement in the gas distribution module of FIG. 3A.

FIG. 4A to FIG. 4D are schematic diagrams showing various outlet holes of different shapes.

FIG. 5 is a schematic diagram showing a gas outlet assembly according to an embodiment of the present disclosure.

FIG. 6A to FIG. 6C are schematic diagrams showing a variety of mixing chambers formed with different profile shapes that can be used in the present disclosure.

FIG. 7A and FIG. 7B are a three-dimensional view and a cross section view of a gas distribution module according to a second embodiment of the present disclosure.

FIG. 8A is a partial perspective view of a gas distribution module according to a third embodiment of the present disclosure.

FIG. 8B is a cross section view of the gas distribution module shown in the third embodiment.

FIG. 9 is a cross section view of a gas distribution module according to a fourth embodiment of the present disclosure.

FIG. 10 is a schematic diagram showing the gas distribution module of the fifth embodiment that is configured with different gas out assembly.

FIG. 11 is a three-dimensional view of a gas distribution scanning apparatus according to a first embodiment of the present disclosure.

FIG. 12A is a cross section view of the gas distribution scanning apparatus of FIG. 11.

FIG. 12B is a cross section view of a gas distribution scanning apparatus according to a second embodiment of the present disclosure.

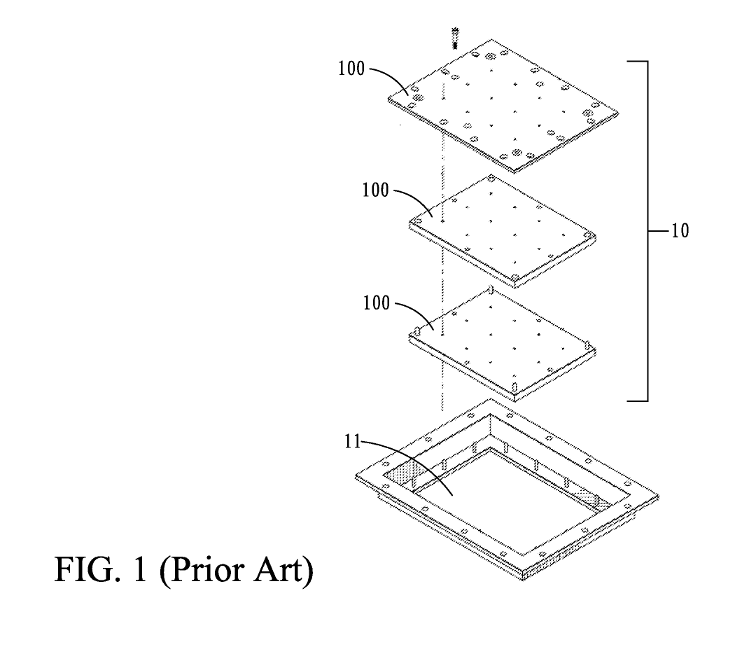

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

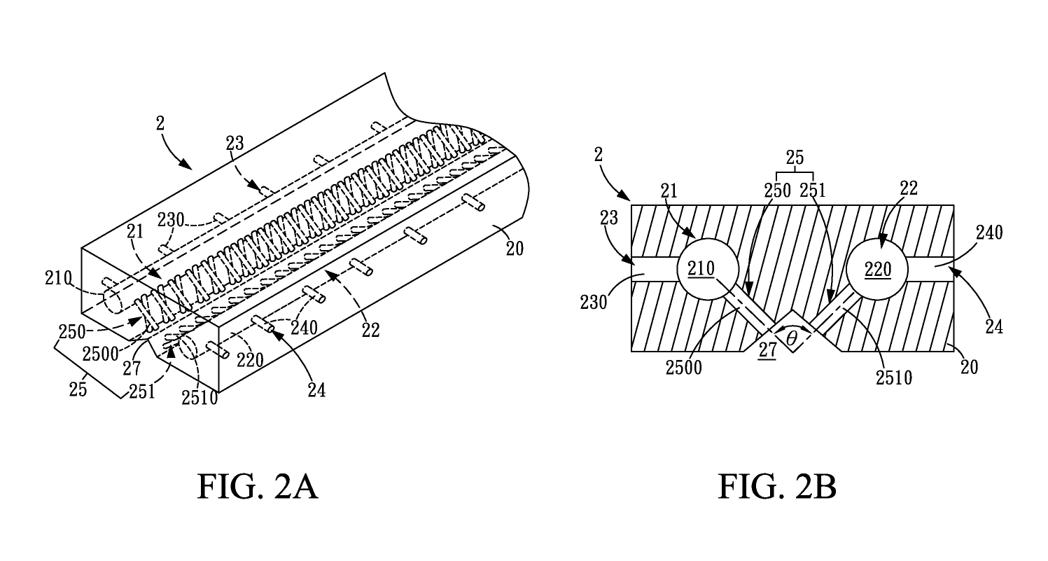

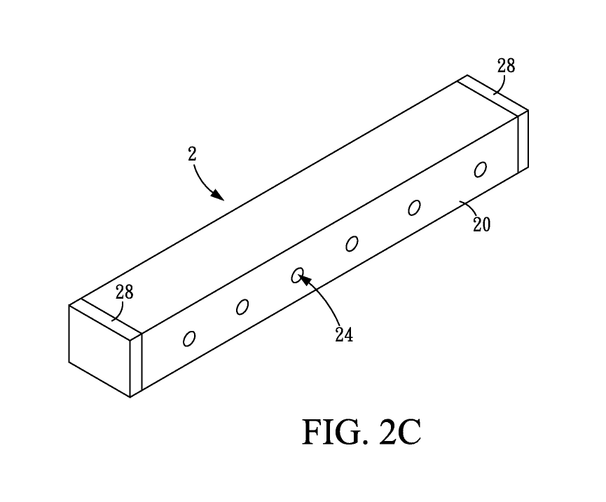

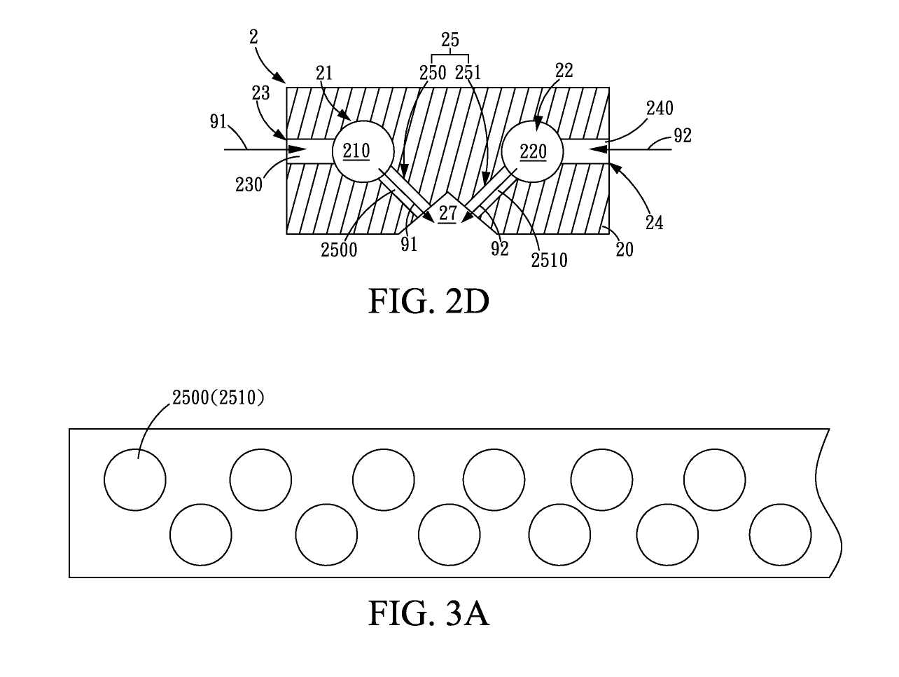

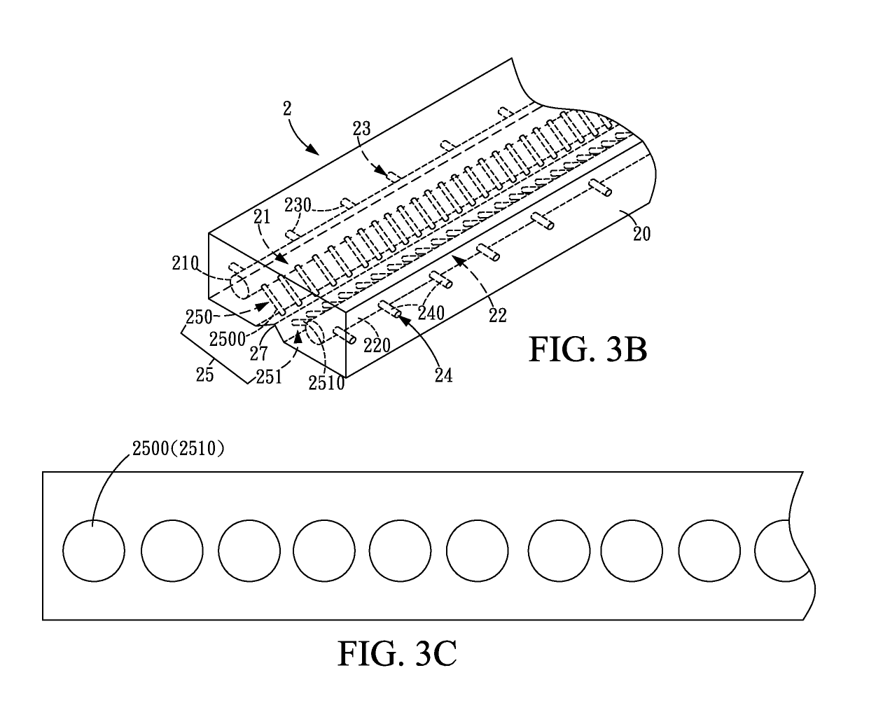

Please refer to FIG. 2A and FIG. 2B, which are a perceptive view and a cross section view of a gas distribution module according to a first embodiment of the present disclosure. In this embodiment, the gas distribution module 2 is composed of a frame 20, a pair of diffusion chamber assemblies 21, 22, a pair of gas inlet assemblies 23, 24 and a gas outlet assembly 25, The frame 20, being a metallic structure or a non-metallic structure, is constructed as a bar-like structure with rectangular cross-section, but it is not limited thereby. The two diffusion chamber assemblies 21, 22 are formed respectively inside the frame 20 at positions proximate to the two opposites thereof. As shown in FIG. 2B, each of the two diffusion chamber assemblies 21, 22 is configured with a diffusion chamber, i.e. the two diffusion chambers 210. 220 in respective, whereas the two diffusion chambers 210. 220 are formed boring through the frame 20 while being connected respectively to the pair of gas inlet assemblies 23, 24 and the gas outlet assembly 25. In this embodiment, each of the two gas inlet assemblies 23, 24 can be composed of at least one gas inlet channel that is connected in communication with its corresponding diffusion chambers 210. 220, as the plural gas inlet channels 230, 240 shown in FIG. 2A and FIG. 2B. In addition, in this embodiment, the gas outlet assembly 25 includes a pair of outlet channel sets 250, 251, and each of the two outlet channel sets 250, 251 is composed of a plurality of outlet channels 2500, 2501. Please refer to FIG. 3A, which is a schematic diagram showing one type of outlet hole arrangement in the gas distribution module of FIG. 2A. As shown in FIG. 3A, the outlet channels 2500, that are parts of the outlet channel sets 250, are alternatively arranged, which is also true for the outlet channels 2501. Such alternating arrangement is specific design for enabling gases to be distributed uniformly onto a substrate during the gas distribution module 2 is driven to move in a scanning process. However, the outlet channels 2500 or the outlet channels 2501 can be arranged differently, as those being aligned in a line shown in FIG. 3B and FIG. 3C, that they can be are arranged into any manner at will without any limitation.

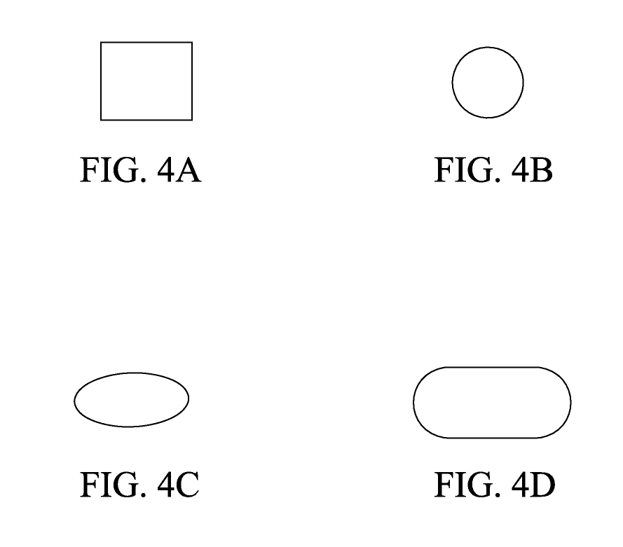

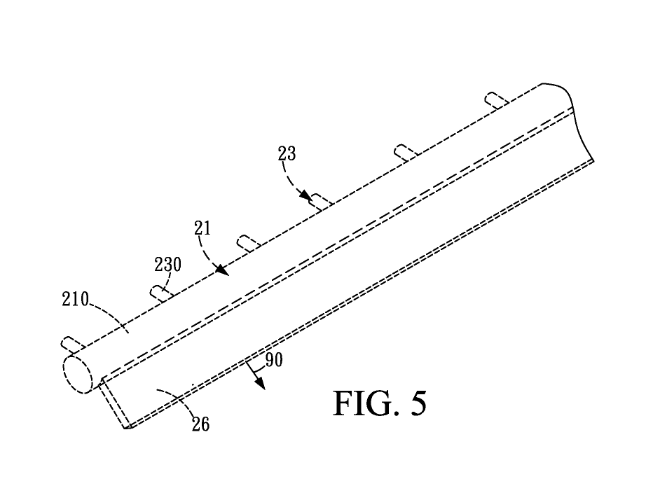

Please refer to FIG. 4A to FIG. 4D, which are schematic diagrams showing various outlet holes of different shapes. It is noted that the shape of the outlet hole for each outlet channel 2500 or each outlet channel 2501 can be formed into any shape at will and without any limitation, so that it is not limited by those shown in FIG. 4A to FIG. 4D. For instance, it can be shaped into a polygon as the rectangle shown in FIG. 4A, or into a shape composed of at least one arc as the circle shown in FIG. 4B, the ellipse shown in FIG. 4C, or the rounded bar shown in FIG. 4D. Please refer to FIG. 5, which is a schematic diagram showing a gas outlet assembly according to an embodiment of the present disclosure. For simplicity, only a portion of the gas outlet assembly 25 that is connected in communication with the diffusion chamber 210 is shown in FIG. 5 for illustration. As shown in FIG. 5, the portion of the gas outlet assembly 25 is formed as a slot conduit 26 that is connected in communication with the diffusion chamber assembly 21.

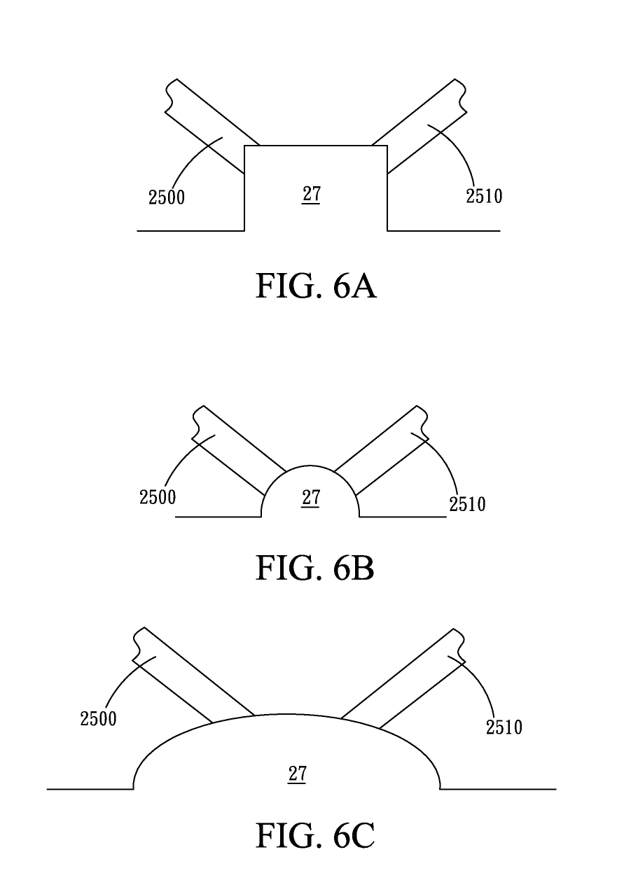

Back to FIG. 2A and FIG. 2B, the outlet holes of the gas outlet assembly 25 are connected to a mixing chamber 27 that is provided for receiving gases discharged from the gas outlet assembly 25 and thus facilitating the mixing of the received gases. In this embodiment, the cross section of the mixing chamber 27 is formed as a triangle, but it is not limited thereby. For instance, the cross section can be a rectangle as shown in FIG. 6A, or a shape composed of at least one arc as the semi-circle shown in FIG. 6B and the semi-ellipse shown in FIG. 6C. It is noted that the effectiveness of the gas distribution module 2, as the one shown in FIG. 2A and FIG. 2B, will not be affected if there is no such mixing chamber 27. However, the configuration of the mixing chamber 27 will certainly improve the uniformity of the gas distribution using the gas distribution module 2. As shown in FIG. 2, there will be an included angle θ to be formed between two axial lines of two outlet channels 2500, 2501 respectively belonging to different outlet channel sets 250, 251 that are disposed corresponding to each other. By the formation of the included angle θ between the corresponding outlet channels 2500, 2501, gases being discharged from the outlet channels 2500 will collide with those discharged form the outlet channels 2501, and thus the uniformity of the intended gas mixture will be improved. Similarly, for the gas outlet assembly formed with the slot conduits 26 as that shown in FIG. 5, there is also an included angle to be formed between the normal to the two surfaces where the two slot conduits are opened to the frame 20, i.e. the included angle is formed between the two normal vectors 90 of the two slot conduits 26. Moreover, as shown in FIG. 2C, the two openings of each diffusion chambers 210, 220 that are positioned corresponding to two opposite sides of the frame 20 are sealed respectively by two side panels 28 attached respectively to the two opposite sides of the frame 20, while the opening of mixing chamber 27 is also being sealed, by that the system of the gas diffusion chamber assemblies is sealed.

Please refer to FIG. 2D, which is a schematic diagram showing how reaction gases are being guided to flow independently into two separated diffusion chambers and then into a mixing chamber to be mixed according to the present disclosure. In FIG. 2D, there are two different reaction gases 91, 92, which can be any gases as required by the manufacture process without any restriction, being fed into the frame 20 respectively through the two gas inlet assemblies 23, 24 that are arranged independently at the two sides of the frame 20. Taking the feeding of the gas 91 for example, after passing the gas inlet channel 230, the gas 91 enters the diffusion chamber 210 where it will be diffused first without entering into the outlet channels 2500 directly, since the outlet channels 2500 are not aligned exactly with their corresponding gas inlet channel 230 but there are misaligned by an angle, and thereby, the gas 91 is diffused and distributed more evenly and uniformly during the zigzagging flowing path for preventing the gas 91 from concentrating in an area of the gas out assembly 25 proximate to the gas inlet assembly 23. It is noted that the foregoing description is also true for the gas 92. In addition, since there is an included angle θ to be formed between two axial lines of two outlet channels 2500, 2501 respectively belonging to different outlet channel sets 250, 251 that are disposed corresponding to each other, the gas 91 being discharged from the outlet channels 2500 will collide with the gas 92 discharged form the outlet channels 2501, and thus the uniformity of the mixture of the two gases 91, 92 will be improved.

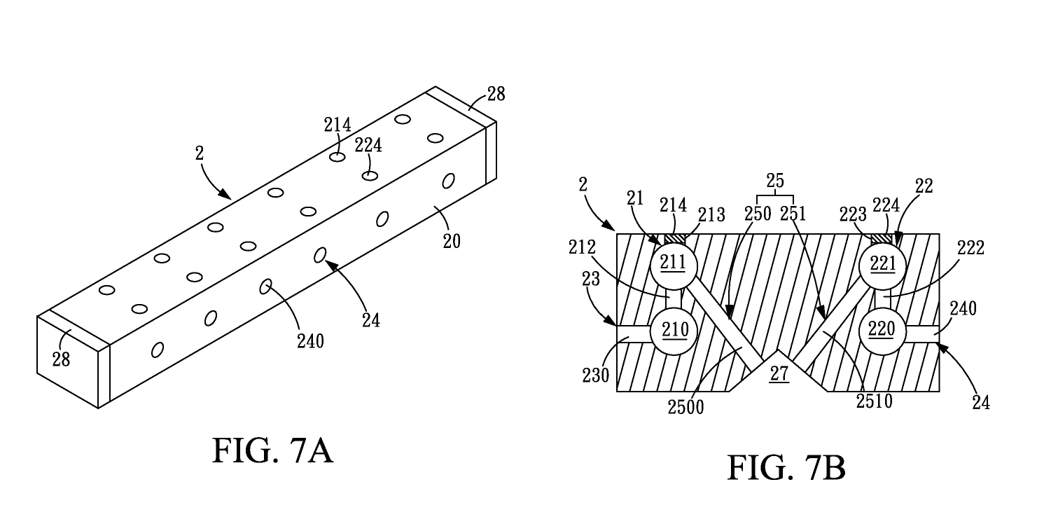

Please refer to FIG. 7A and FIG. 7B, which are a three-dimensional view and a cross section view of a gas distribution module according to a second embodiment of the present disclosure. The gas distribution module shown in the second embodiment is basically the same as the one shown in the first embodiment, but is different in the design relating to the diffusion chamber assembly. That is, in the second embodiment, instead of one diffusion chamber, each diffusion chamber assembly is configured with a plurality of diffusion chambers. As shown in FIG. 7A and FIG. 7B, the diffusion chamber assembly 21 is configured with a first diffusion chamber 210 and a second diffusion chamber 211, while the diffusion chamber assembly 22 is configured with a first diffusion chamber 220 and a second diffusion chamber 221, in that the second diffusion chamber 211 is connected in communication with its corresponding first diffusion chamber 210 by the use of a channel 212, and similarly the second diffusion chamber 221 is connected in communication with its corresponding first diffusion chamber 220 by the use of a channel 222. As the channels 212, 222 are formed by drilling, there are dill holes 213, 223 formed on the second diffusion chambers 211, 221 respectively at positions corresponding to the channels 212, 222, whereas the drill holes 213, 223 can be sealed by the use of plugs 214, 224 for preventing gases from leaking. As for the amount of the channels 212, 222 that are required in the gas distribution module, it is not limited by any number and thus can be determined as required, only if they can successfully and smoothly guiding the corresponding gases to flow from the first diffusion chambers 210, 220 to the second diffusion chambers 211, 221. It is noted that the second diffusion chamber 211 is connected to the outlet channel set 250 of the gas outlet assembly 25, while the second diffusion chamber 221 is connected to the outlet channel set 251 of the gas outlet assembly 25, or even they can be connected to the gas outlet assembly 25 through the slot conduits 26, as those shown in FIG. 5. Similarly, the two openings of each first diffusion chambers 210, 220 as well as two openings of each second diffusion chambers 211, 221 that are positioned corresponding to two opposite sides of the frame 20 are sealed respectively by two side panels 28 attached respectively to the two opposite sides of the frame 20, while the opening of mixing chamber 27 is also being sealed, by that the system of the gas diffusion chamber assemblies is sealed. Similarly, taking the feeding of the gas 91 for example, after passing the gas inlet channel 230, the gas 91 enters the diffusion chamber 210 where it will be diffused first without entering into the channel 212 directly since the channel 213 are not aligned exactly with their corresponding gas inlet channel 230 but there are misaligned by an angle; and after entering into the second diffusion chamber 211 through the channel 213, the gas 91 will be diffused again without entering into outlet channels 2500 directly since the outlet channels 2500 are not aligned exactly with their corresponding channel 213 but there are misaligned by an angle, and thereby, the gas 91 is diffused and distributed more evenly and uniformly during the zigzagging flowing path for preventing the gas 91 from concentrating in an area of the gas out assembly 25 proximate to the gas inlet assembly 23. It is noted that the foregoing description is also true for the gas 92. Moreover, since the gas flowing relating to the gas outlet assembly 25 in this second embodiment is the same as that in the first embodiment, it is not described further herein.

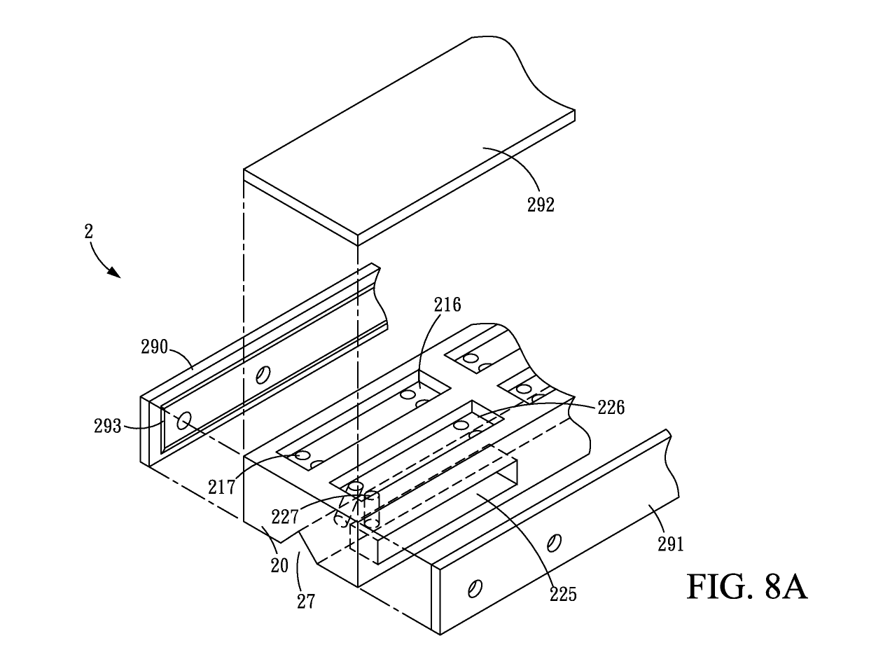

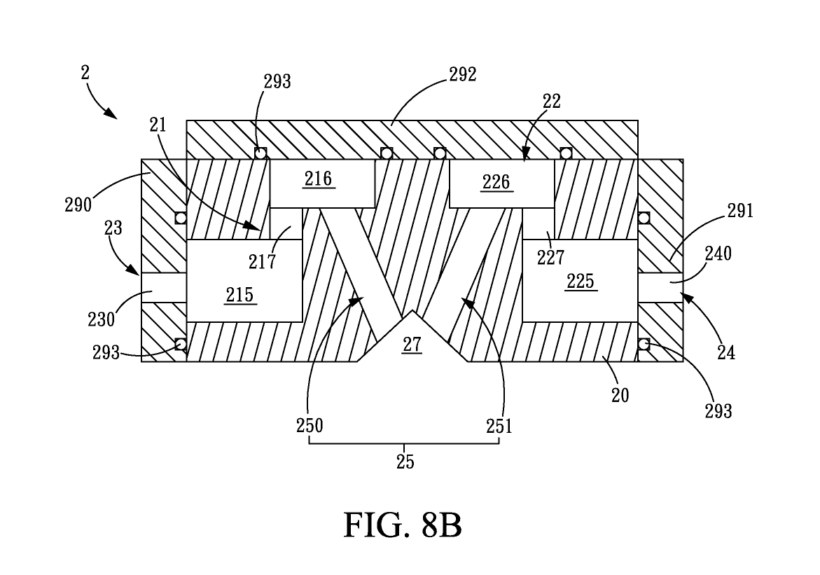

Please refer to FIG. 8A and FIG. 8B, which are a partial perspective view and a cross sectional view of a gas distribution module according to a third embodiment of the present disclosure. The gas distribution module shown in the third embodiment is basically the same as the one shown in the second embodiment, but is different in that: the method used for processing the diffusion chamber assemblies is different and also the resulting structure of the diffusion chamber assemblies is different. As the first and the second diffusion chambers 210, 220, 211, 221 are formed by drilling, the formation as well as the configuration of those diffusion chambers are usually being restricted under the limitation of the drill length, that the length of a drill used for drill has its limit and can not be increased limitlessly with the size increasing of the substrate to be processed. However, by the design shown in FIG. 8A and FIG. 8B, the size of the diffusion chambers, especially their lengths, can be increased greatly without being defined under the limitation of the drill length, and thus the design shown in the third embodiment is suitable for achieving large-size gas distribution module adapted for providing uniform distribution of gases on large-size substrates. In the embodiment shown in FIG. 8A and FIG. 8B, instead of the aforesaid chamber configuration, there are two first diffusion grooves 215, 225 and their corresponding second diffusion grooves 216, 226 being formed inside the frame 20, whereas according to the groove design, each of the first and the second diffusion grooves can be built in a length almost equal to that of the frame 20. Moreover, each of the diffusion grooves can be formed as a single groove or can be an assembly of a plurality of sub-grooves. It is noted that the formation of such diffusion grooves can be achieved by milling.

As shown in FIG. 8B, the two first diffusion grooves 215, 225 are respectively arranged proximate to two opposites of the frame 20, whereas there are first caps 290, 291 attached respectively to the two sides of the frames 20 for covering and thus sealing their corresponding first diffusion grooves 215, 225. As for the two second diffusion grooves 216, 226, they are arranged on the top surface of the frame 20 at position above their corresponding first diffusion grooves 215, 225 while being connected in communication with the two first diffusion grooves 215, 225 by the use of at least one channels 217, 227, and similarly, there is a second cap 292 attached to the top surface of the frame 20 for covering and thus sealing the two second diffusion grooves 216, 226. In addition, for further ensuring the airtight of the sealing by the first and the second caps 290, 291, 292, there are airtight components 293, such as o-rings, being sandwiched between the caps 290, 291, 292 and the frame 20. As the gas diffusion and the gas mixture in the aforesaid gas distribution module are performed similar to the foregoing embodiments, they are not described further herein. Moreover, it is noted that he two gas inlet assemblies 23, 23 in this third embodiment are disposed respectively on the two first caps 290, 291.

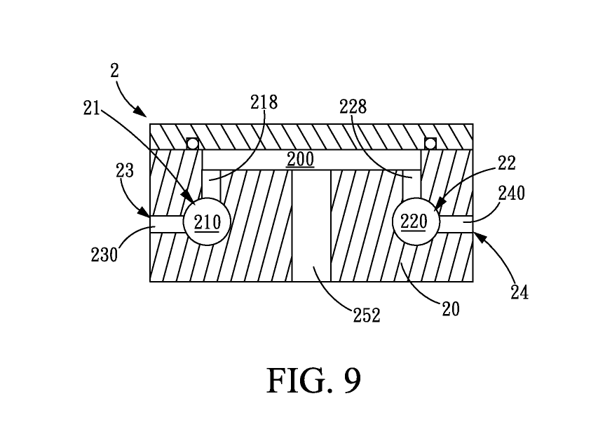

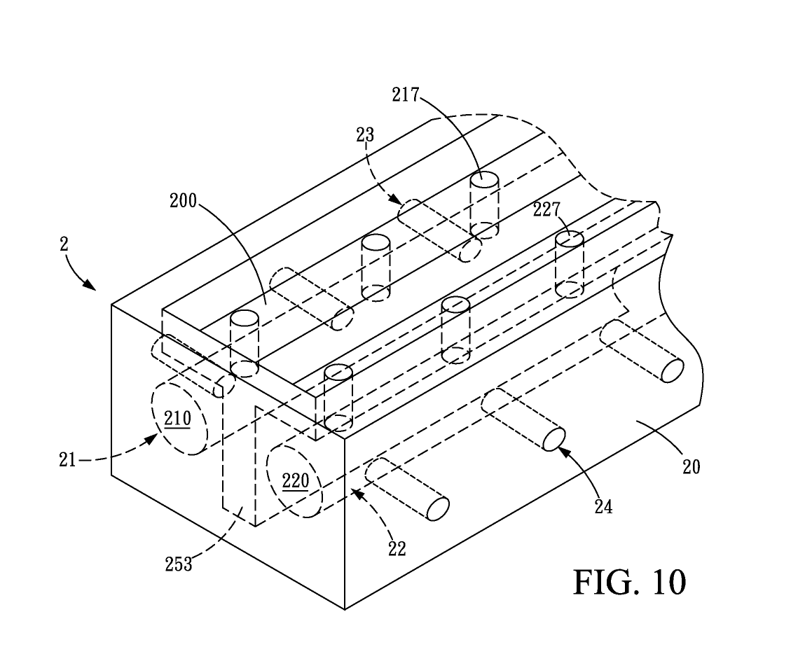

In the gas distribution modules disclosed in the first, second and third embodiments, the reaction gases will not be mixed inside the gas distribution modules until it is being discharged out of the same. That is, each of the aforesaid gas distribution modules are designed with independent gas passages, provided for guiding different reaction gases to be delivered and diffused via different gas passages that are independent to each other. However, the reaction gases can be mixed in advance inside the gas distribution modules before being discharged, and it is obvious that such variations are not to be regarded as a departure from the spirit and scope of the disclosure. Please refer to FIG. 9, which is a cross section view of a gas distribution module according to a fourth embodiment of the present disclosure. In the embodiment shown in FIG. 9, the gas inlet assemblies 23, 24 and the diffusion chamber assemblies 21, 22 are constructed basically the same as those disclosed in the embodiments of FIG. 2B and FIG. 7B, but are different in that: the gas outlet assembly is substantially an assembly of a plurality of channels 252 that are disposed independent to each other inside the frame and provided for a mixture of reaction gases gas to flow therein. Moreover, the assembly of the plural channels 252 is connected in communication with the diffusion chamber assemblies 21, 22 through a mixing chamber 200 that is formed inside the frame 20. As shown in FIG. 9, the mixing chamber 200 is connected in communication respectively to the two first diffusion chambers 210, 220 via two different channels 218, 228. Please refer to FIG. 10, which is a schematic diagram showing the gas distribution module of the fifth embodiment that is configured with different gas out assembly. As shown in FIG. 10, the gas out assembly 25 is substantially an open groove 253 provided for a mixture of gases to be delivered thereto. Operationally, when two different reaction gases are fed inside the frame 20 of the gas distribution module of the fourth embodiment respectively through the two gas inlet assemblies 23, 24, the two reaction gases will first be diffused independently inside their respective diffusion chambers 210, 220, and then the diffused gases are guided to flow into the mixing chamber 200 where they are mixed, and thereafter, the mixture of reaction gases is discharged out of the gas distribution module from the gas outlet assembly 25. Although there is only one diffusion chamber 210 being configured in the corresponding diffusion chamber assemblies 21 in the embodiment of FIG. 9, it is not limited thereby and thus there can be a plurality of diffusion chambers in one diffusion chamber assembly, as those shown in FIG. 7A and FIG. 7B. It is noted that the above description is also true for the diffusion chamber assembly 22.

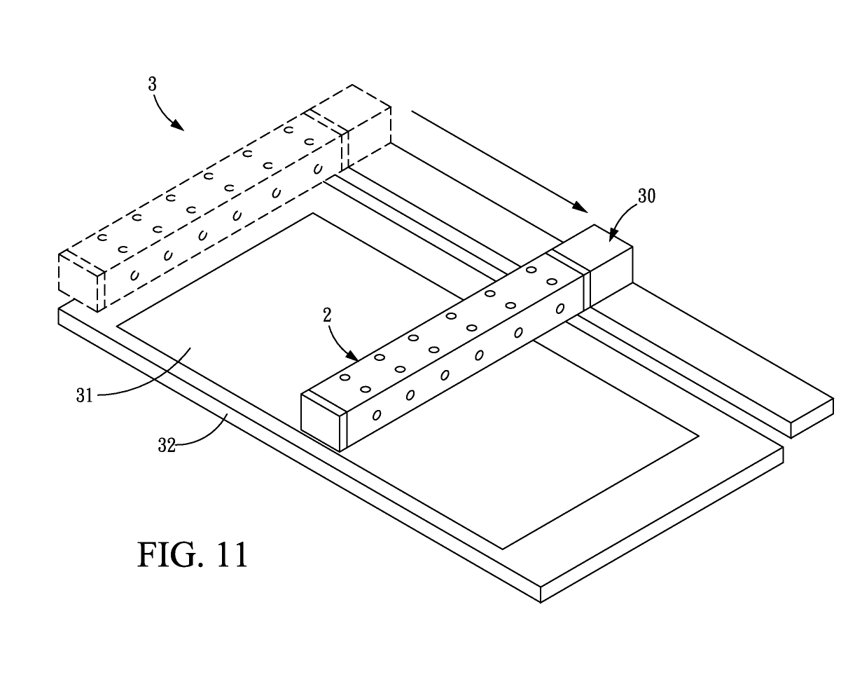

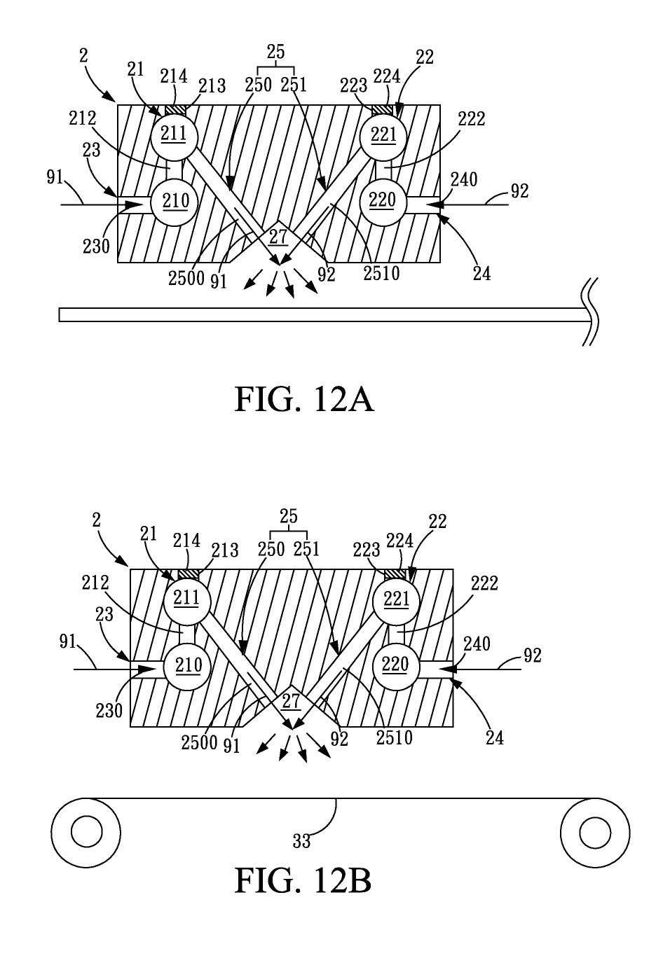

Please refer to FIG. 11, which is a three-dimensional view of a gas distribution scanning apparatus according to a first embodiment of the present disclosure. As shown in FIG. 11, the gas distribution scanning apparatus 3 comprises: a gas distribution module 2 and a displacement driving unit 30, in which the displacement driving unit 30 is used for enabling a displacement movement of at least one dimension. In this embodiment, the displacement driving unit 30 is used for enabling a three-dimensional displacement movement. Moreover, the gas distribution module 2, being disposed at a side of a substrate 31, is coupled to the displacement driving unit 30, by that the gas distribution module 2 can be driven to move according to the linear displacement enabled by the displacement driving unity 30 and perform a linear scanning process. It is noted that the gas distribution module 2 used in the aforesaid gas distribution scanning apparatus can be any gas distribution module selected from the four different gas distribution modules in the abovementioned four embodiments. As shown in FIG. 12A, the gas distribution scanning apparatus 3 is able to provide uniform distribution of a mixture gases 91, 92 onto a substrate 31 in a vacuum deposition process. In the vacuum deposition process performed in FIG. 12A using the gas distribution scanning apparatus of FIG. 11, the gas distribution module 2 is being driven to move while the substrate 31 is being hold stationary. On the other hand, in another embodiment when the displacement driving unit 30 is couple to a carrier 32 carrying the substrate 30 instead of being coupled to the gas distribution module 2, the substrate 31 is being driven to move along with the moving of the carrier 32 enabled by the displacement driving unit 30, while the gas distribution module 2 is being hold stationary. In addition, the substrate 31 can be a flat plate substrate, as that shown in FIG. 12A, or can be a roll-to-roll flexible substrate 33, as that shown in FIG. 12B.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A gas distribution module, comprising:
a frame;
a pair of diffusion chamber assemblies, formed inside the frame;
a pair of gas inlet assemblies, connected respectively in communication with the pair of diffusion chamber assemblies; and
a gas outlet assembly, formed inside the frame while being connected in communication with the pair of diffusion chamber assemblies;
wherein, the gas outlet assembly is further configured with at least one outlet hole, each being arranged at a position on a surface of the frame.

2. The gas distribution module of claim 1, wherein each of the two diffusion chamber assemblies is configured with at least one first diffusion chamber, being formed inside the frame while allowing the two openings thereof that are positioned corresponding to two opposite sides of the frame so as to be sealed respectively by two side panels attached respectively to the two opposite sides of the frame.

3. The gas distribution module of claim 1, wherein the pair of gas inlet assemblies are disposed respectively at the two sides of the frame; and each of the two gas inlet assemblies is configured with at least one inlet channel.

4. The gas distribution module of claim 1, wherein each of the diffusion chamber assemblies is further comprised of: a first diffusion chamber; and a second diffusion chamber, connected to the first diffusion chamber by the use of at least one channel; and each of the first and the second diffusion chamber is formed with two openings that are positioned corresponding to two opposite sides of the frame so as to be sealed respectively by two side panels attached respectively to the two opposite sides of the frame.

5. The gas distribution module of claim 1, wherein the gas outlet assembly is configured with a pair of slot conduits, respectively connected in communication with the pair of diffusion chamber assemblies while enabling an included angle to be formed between the normal to the two surfaces where the two slot conduits are opened thereat.

6. The gas distribution module of claim 1, wherein the gas outlet assembly is configured with a pair of outlet channel sets, and each composed of a plurality of outlet channels in a manner for allowing an included angle to be formed between two axial lines of two outlet channels belonging to different outlet channel sets that are disposed corresponding to each other, while enabling the plural outlet channels of any one of the two outlet channel sets to be arranged in a manner selected from the group consisting of: they are aligned in a line, and they are alternatively arranged.

7. The gas distribution module of claim 1, wherein the frame further has a mixing chamber formed on a surface thereof in a manner that the mixing chamber is connected in communication with the at least one outlet hole of the gas outlet assembly, while allowing the cross section of the mixing chamber to be formed in a shape selected from the group consisting of: a triangle, a rectangle, and a arc shape;
and the profile of the at least one outlet hole is formed in a shape selected from the group consisting of: a polygon and an arc shape.

8. The gas distribution module of claim 1, wherein the gas outlet assembly is substantially an open groove provided for a mixture of gases to be delivered thereto or an assembly of a plurality of channels provided for the mixture of gases to flow therein, and is connected in communication with the pair of diffusion chamber assemblies by the use of a mixing chamber that is formed inside the frame.

9. The gas distribution module of claim 1, wherein each of the diffusion chamber assemblies is further comprised of:
a first diffusion groove, formed on the surface of the frame while allowing the same to be covered by a first cap that is disposed on the frame at a position corresponding to the first diffusion groove; and
a second diffusion groove, formed on the surface of the frame while enabling the same to connect in communication with the first diffusion groove by the use of at least one channel, and simultaneously allowing the same to be covered by a second cap.

10. A gas distribution scanning apparatus, comprising:
a gas distribution module, further comprising:
a frame;
a pair of diffusion chamber assemblies, formed inside the frame;
a pair of gas inlet assemblies, connected respectively in communication with the pair of diffusion chamber assemblies; and
a gas outlet assembly, formed inside the frame while being connected in communication with the pair of diffusion chamber assemblies, and the gas outlet assembly having at least one outlet hole, each being arranged at a position on a surface of the frame;
and
a displacement driving unit, for enabling a displacement movement in at least one dimension in a manner that the gas distribution module is driven to move relative to a substrate that is disposed at a side of the same.

11. The gas distribution scanning apparatus of claim 10, wherein each of the two diffusion chamber assemblies is configured with at least one first diffusion chamber, being formed inside the frame while allowing the two openings thereof that are positioned corresponding to two opposite sides of the frame so as to be sealed respectively by two side panels attached respectively to the two opposite sides of the frame.

12. The gas distribution scanning apparatus of claim 10, wherein the two gas inlet assemblies are disposed respectively at the two sides of the frame; and each of the two gas inlet assemblies is configured with at least one inlet channel.

13. The gas distribution scanning apparatus of claim 10, wherein each of the diffusion chamber assemblies is further comprised of: a first diffusion chamber; and a second diffusion chamber, connected to the first diffusion chamber by the use of at least one channel; and each of the first and the second diffusion chamber is formed with two openings that are positioned corresponding to two opposite sides of the frame so as to be sealed respectively by two side panels attached respectively to the two opposite sides of the frame.

14. The gas distribution scanning apparatus of claim 10, wherein the gas outlet assembly is configured with a pair of slot conduits, respectively connected in communication with the pair of diffusion chamber assemblies while enabling an included angle to be formed between the normal to the two surfaces where the two slot conduits are opened thereat.

15. The gas distribution scanning apparatus of claim 10, wherein the gas outlet assembly is configured with a pair of outlet channel sets, and each composed of a plurality of outlet channels in a manner for allowing an included angle to be formed between two axial lines of two outlet channels belonging to different outlet channel sets that are disposed corresponding to each other, while enabling the plural outlet channels of any one of the two outlet channel sets to be arranged in a manner selected from the group consisting of: they are aligned in a line, and they are alternatively arranged.

16. The gas distribution scanning apparatus of claim 10, wherein the frame further has a mixing chamber formed on a surface thereof in a manner that the mixing chamber is connected in communication with the at least one outlet hole of the gas outlet assembly, while allowing the cross section of the mixing chamber to be formed in a shape selected from the group consisting of: a triangle, a rectangle, and a arc shape; and the profile of the at least one outlet hole is formed in a shape selected from the group consisting of: a polygon and an arc shape.

17. The gas distribution scanning apparatus of claim 10, wherein the gas outlet assembly is substantially an open groove provided for a mixture of gases to be delivered thereto or an assembly of a plurality of channels provided for the mixture of gases to flow therein, and is connected in communication with the pair of diffusion chamber assemblies by the use of a mixing chamber that is formed inside the frame.

18. The gas distribution scanning apparatus of claim 10, wherein each of the diffusion chamber assemblies is further comprised of:
a first diffusion groove, formed on the surface of the frame while allowing the same to be covered by a first cap that is disposed on the frame at a position corresponding to the first diffusion groove; and
a second diffusion groove, formed on the surface of the frame while enabling the same to connect in communication with the first diffusion groove by the use of at least one channel, and simultaneously allowing the same to be covered by a second cap.

19. The gas distribution scanning apparatus of claim 10, wherein the displacement movement of at least one dimension enabled by the displacement driving unit is performed in a manner selected from the group consisting of: the gas distribution module is driven by the displacement driving unit to move in the displacement movement of at least one dimension, and a carrier provided for carrying the substrate is driven by the displacement driving unit to move in the displacement movement of at least one dimension.

20. The gas distribution scanning apparatus of claim 10, wherein the substrate is selected from the group consisting of: a flat plate substrate and a roll-to-roll flexible substrate.
